(19) United States
(12) Patent Application Publication
(10) Pub. No.: US 2010/0023435 A1
(43) Pub. Date: Jan. 28, 2010

(54) Balance Shared Payment Card

(76) Inventors: Richard A. Elko, Chester Springs, PA (US); James G. Blume, Douglassville, PA (US); Lori M. Adamski, Reading, PA (US); Holly L. Wolf, Fleetwood, PA (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/181,122

(22) Filed: Jul. 28, 2008

(51) Int. Cl. G06Q 40/00; G06K 19/06

(52) U.S. Cl. 705/35; 705/1; 235/493

(57) ABSTRACT

A payment card having account information associated therewith may include a substrate and a magnetic stripe adhered to a first side of the substrate. The magnetic stripe may be encoded with the account information. The account information may be associated with, for example, a non-profit organization that may be selected to receive a residual account balance of the payment card.

### BACKGROUND

Payment cards such as prepaid credit cards, prepaid debit cards, stored-value cards such as gift cards, or the like have become increasingly popular as gifts for many occasions. For example, many consumers are now purchasing a payment card such as a prepaid credit card, a prepaid debit card, a stored-value card, or the like as a substitute for cash or physical goods sold by a merchant such as a retail store. The payment card may include a monetary balance associated therewith that may be prepaid by the consumer. The consumer may then give the payment card to a recipient as a gift. Upon receipt, the recipient may apply the monetary balance of the payment card towards, for example, a purchase of goods and/or services. Unfortunately, the payment card may expire or may be lost before the monetary balance may be fully used by the recipient. Additionally, the recipient may not use the payment card, because, for example, the recipient may not have time to shop. Thus, an un-recouped monetary balance may remain on the payment card. Typically, a merchant or a financial institution associated with the payment card yields a gain from such an un-recouped monetary balance.

### SUMMARY

A payment card having account information associated therewith may include a substrate and a magnetic stripe adhered to a first side of the substrate. The magnetic stripe may be encoded with the account information. According to one embodiment, the account information may be associated with, for example, an organization that may be selected to receive a residual account balance of the payment card.

Methods and systems for ordering a payment card, associating an organization with a payment card, and/or providing a balance of a payment card to an organization may also be provided. In one such embodiment, a payment card system may be provided by a payment card provider. The payment card system may receive order information for purchasing a payment card. The order information may include a balance that may be credited to the payment card and an organization that may be selected to receive a remaining balance of the payment card. The payment card system may generate an account for the payment card based on the received order information. The account may include the balance and an indication of the selected organization. The payment card system may then issue the payment card corresponding to the generated account.

According to another embodiment, a payment card system may also receive a selection of the organization. For example, in one embodiment, the payment card may be issued without a selected organization. The payment card system may receive the selected organization when, for example, the payment card may be activated. The payment card system may then associate the selected organization with the account of the payment card. The payment card system may also store the association of the selected organization with the account of the payment card such that the payment card system may use the stored association to provide the account balance to the selected organization.

Additionally, a payment card system may provide a balance to an organization associated with a payment card. For example, the payment card system may determine whether the payment card is valid. If the payment card may be invalid, for example, if the payment card may have expired or a recipient may have donated the balance early, the balance associated with the payment card may be provided to the organization.

### BRIEF DESCRIPTION OF THE DRAWINGS

FIGS. 1A-1B depict front and back views, respectively, of an example embodiment of a payment card.

FIGS. 2A-2B depict example embodiments of systems for associating an organization with a payment card.

FIGS. 3-13 depict example interfaces for ordering a payment card, associating an organization with a payment card, and/or providing a balance of a payment card to an organization.

FIG. 14 depicts a flow diagram of an example method for ordering a payment card, associating an organization with a payment card, and/or providing a balance of a payment card to an organization.

### DETAILED DESCRIPTION OF ILLUSTRATIVE EMBODIMENTS

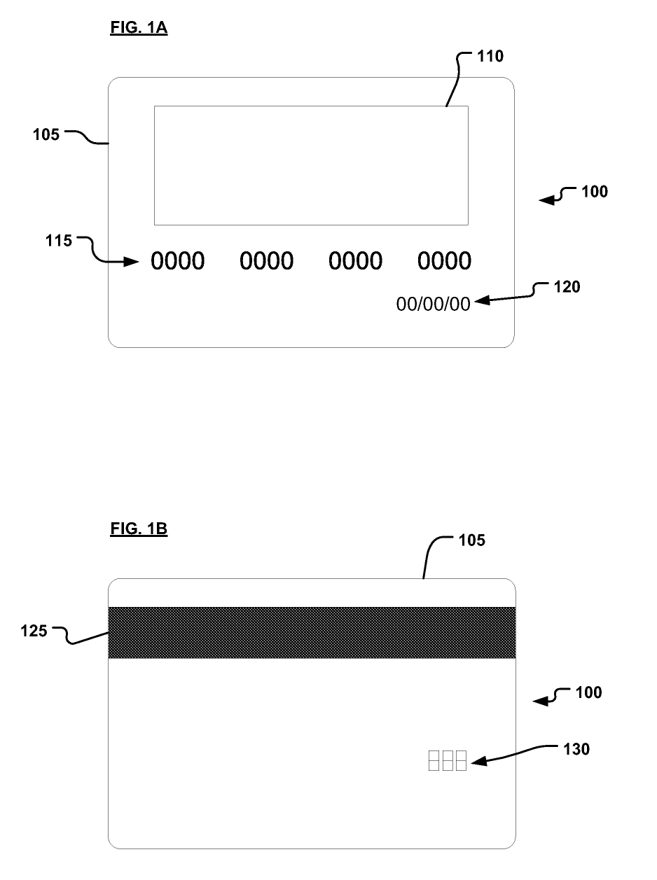

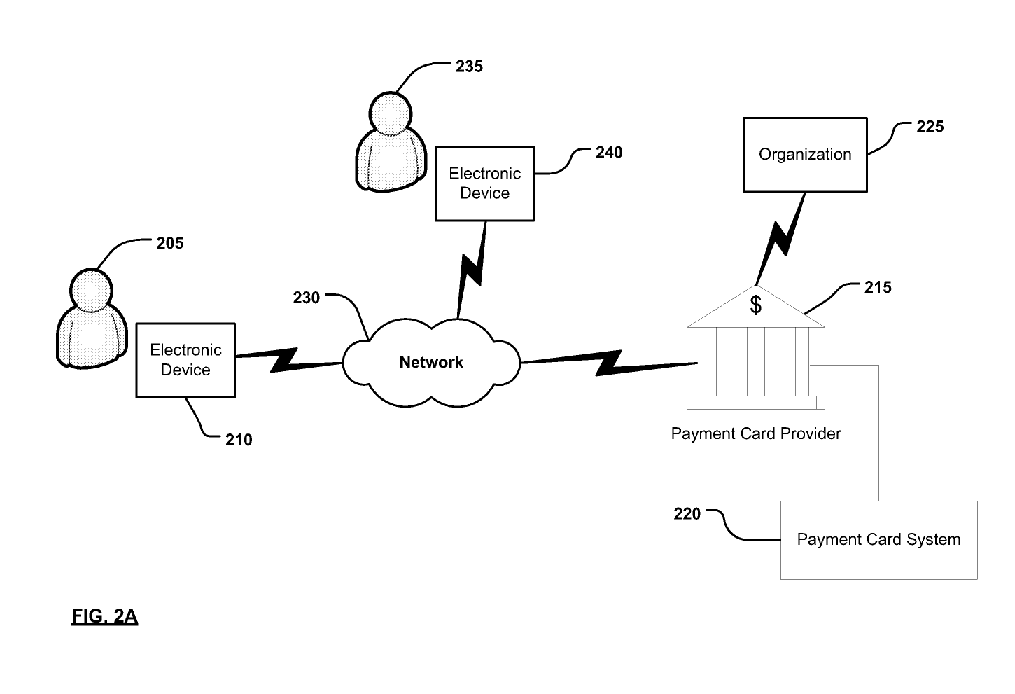

FIGS. 1A-1B depict front and back views, respectively, of an example embodiment of a payment card 100. The payment card 100 may be a prepaid debit card, a prepaid credit card, a stored-value card such as a gift card, or any other suitable payment instrument that may include a monetary balance prepaid by a purchaser on behalf of, for example, a recipient. The payment card 100 may allow a recipient to purchase goods or services, for example, through electronic dispensing of funds in an account that includes the monetary balance prepaid by the consumer purchasing the payment card 100. As shown in FIGS. 1A and 1B, the payment card 100 may include a substrate 105. The substrate 105 of the payment card 100 may be made of, for example, a polymer such as plastic, thermoplastic, polyvinyl chloride acetate (PVCA). According to an example embodiment, the substrate 105 may include several layers of, for example, polymers laminated together when pressure and heat are applied thereto.

As shown in FIG. 1A, the payment card 100 may include an emblem 110. The emblem 110 may include texts, graphics, holograms, pictures, or the like. For example, the emblem 110 may include the logo of a card sponsor such as a bank, a retail store, or the like and/or the logo of an organization such as a charity, an educational institution, a research institution, an environmental organization, an animal organization, a religious organization, an arts organization, and a humanitarian aid organization, or the like that may be associated with the payment card, which will be described in more detail below. The emblem 110 may further include the name of the credit card association supporting the payment card 100 such as Visa®, MasterCard®, American Express®, or the like. According to one embodiment, the emblem 110 may include one or more holograms that may depict the type of card, such as a gift card, a prepaid debit card, a prepaid credit card, or the like associated with the payment card 100. The emblem 110 may be affixed to the front of the payment card 100 using, for example, an adhesive material, screening techniques, hot stamping techniques, or any other suitable printing or adhesive techniques.

According to an example embodiment, the payment card 100 may further include an account identifier 115 that may be embossed on, for example, the front of the substrate 105 of the payment card 100. The account identifier 115 may include a unique account number that may be associated with the account of the payment card 100. The unique account number of the account identifier 115 may include a plurality of characters such as digits, alphanumeric digits, or the like. For example, the payment card 100 may include nine or more digits. By including nine digits or more digits, the account identifier 115 may provide over one billion unique account numbers. Additionally, the account identifier 115 may include an institution identification number and an individual account number that makes up the unique account number. For example, the first few digits of the account identifier 115 may identify an institution such as a bank, a credit card association, a merchant, or the like that may issue the payment card 100. The remaining digits may include, for example, the individual account number of the payment card 100.

According to example embodiments, the account identifier 115 may be used to access account information associated with the account of the payment card 100. For example, as described above, the payment card 100 may be a prepaid credit card, prepaid debit card, stored-value card such as a gift card, or the like. Thus, the account of the payment card 100 may include a monetary balance that may be paid for by a consumer purchasing the payment card 100. The account identifier 115 may be used to access, for example, the monetary balance.

As shown in FIG. 1A, the payment card 100 may further include an expiration date 120 that may be embossed on, for example, the front of the substrate 105 of the payment card 100. In one embodiment, the expiration date 120 may include, for example, the date that the payment card 100 may no longer be valid for use.

As shown in FIG. 1B, the payment card 100 may further include a magnetic stripe 125 adhered to the back of the substrate 105 of the payment card 100. The magnetic stripe 125 may be a rectangular strip on the back side of the payment card 100. The magnetic stripe 125 may be coated with, for example, particles of iron oxide or any other suitable material such that the magnetic stripe 125 may be encoded with binary information. The binary information may include any number of characteristics associated with, for example, the account of the payment card 100 such as the account identifier, expiration date, or the like. For example, when a merchant swipes the credit card, the binary information may be provided through a clearing house to the institution associated with the payment card 100. The received binary information may then be used by the institution to determine, for example, the monetary balance associated with the payment card 100 such that a purchase price may be deducted from the monetary balance associated with the payment card 100 based on the received binary information. The binary information may also be used to verify the authenticity of the payment card 100.

As shown in FIG. 1B, in one embodiment, the payment card 100 may further include a security identifier 130 that may be printed on, for example, the back of the substrate 105 of the payment card 100. The security identifier 130 may include a security code, a merchant code such as an identifier associated with a merchant that may issue the payment card 100, or the like. In one embodiment, the security identifier 130 may be entered by a merchant or a recipient of the payment card 100 to verify the authenticity of the payment card 100.

According to example embodiments, the payment card 100 may include additional information that may be embossed on, printed on, or adhered to the substrate 105 of the payment card 100. For example, the payment card 100 may be a prepaid credit card purchased by a consumer for a recipient such that the payment card 100 may further include a recipient name embossed on the substrate and a signature block adhered to the substrate.

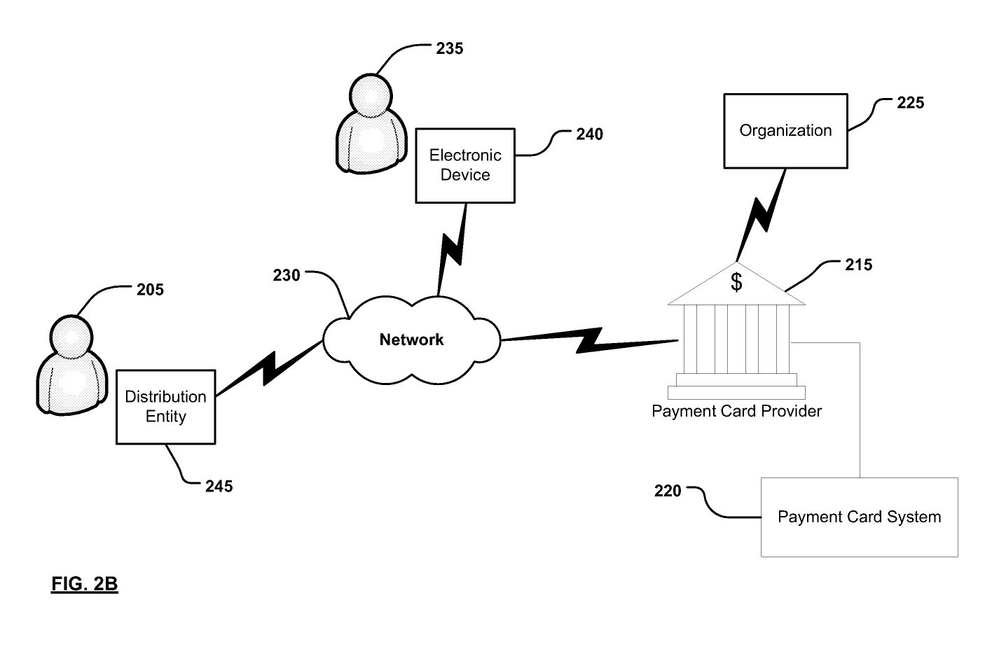

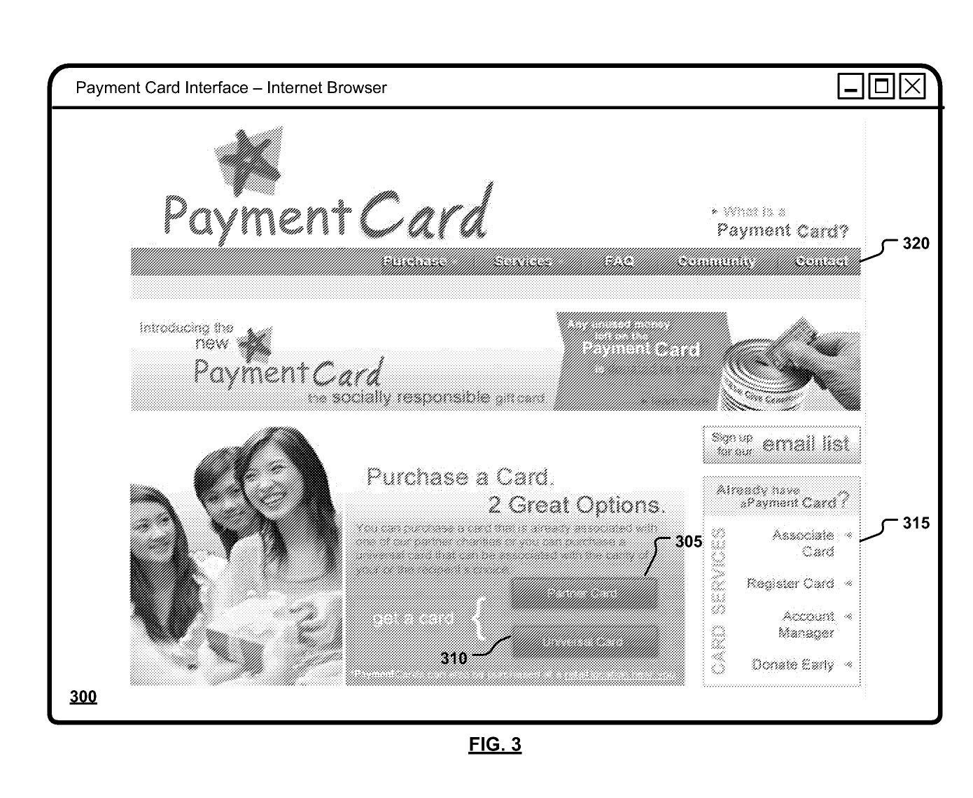

FIGS. 2A-2B depict example embodiments of systems for associating an organization with a payment card such as the payment card 100 shown in FIGS. 1A and 1B. As shown in FIG. 2A, a payment card provider 215 may be in communication, via a network 230, with a consumer 205 via a first electronic device 210 and a recipient 235 via a second electronic device 240. The network 230 may be any suitable communication network such as a telephone network, a wireless network, a local- or wide-area network including a corporate intranet or the Internet, for example.

The payment card provider 215 may be a financial institution such as a bank, a credit card issuer, a merchant, or any other entity that may sponsor a payment card such as a prepaid credit card, prepaid debit card, stored-value card such as a gift card, or the like. According to one embodiment, the payment card provider 215 may include a payment card system 220 implemented therein. The payment card system 220 may include any combination of hardware components such as processors, databases, storage drives, registers, cache, RAM memory chips, data buses, or the like and/or software components such as operating systems, database management applications, or the like. In one embodiment, the payment card system 220 may be a network-based server that may provide an interface such as web pages to the first and second electronic devices 210, 240. In an example embodiment, the consumer 205 and/or the recipient 235 may interact with the interface via the respective first and second electronic devices 210, 240 to, for example, associate an organization with a payment card such as payment card 100, shown in FIGS. 1A and 1B, order a payment card, and/or provide a balance remaining on the payment card to an organization. The payment card system 220 may also include an interactive voice response (IVR) application such that the consumer 205 and/or the recipient 235 may interact with the IVR application via the respective first and second electronic devices 210, 240 to, for example, associate an organization with a payment card, order a payment card, and/or provide a balance remaining on the payment card to an organization.

According to an example embodiment, the payment card system 220 may also store information associated with the payment card that may be sponsored by the payment card provider 215. For example, the payment card system 220 may receive an order for a payment card from, for example, the consumer 205. The order may include information such as an organization that may be selected to receive a monetary balance that may remain on a payment card. Additionally, after receiving a payment card from, for example, the consumer 205, the recipient 235 may access the payment card system 220 to provide information such as the organization that may be selected to receive the monetary balance that may remain on the payment card. The information including the selected organization may be stored in the payment card system 220 such that the payment card provider 215 may use the information to distribute or transfer the balance remaining on the payment card to the organization.

The consumer 205 may be a purchaser or a giver of a payment card such as a prepaid credit card, prepaid debit card, stored-value card such as a gift card, or the like. The consumer 205 may interact with the payment card provider 215 to purchase a payment card and/or select an organization to receive a balance that may remain on the payment card. As described above, the consumer 205 may interact with the payment card provider 215 using, for example, the first electronic device 210. The first electronic device 210 may include hardware components such as a processor, a graphics card, a storage component, a memory component, an antenna, a communication port, or the like. The first electronic device 210 may also include software components such as an operating system that may control the hardware components. According to example embodiments, the first electronic device 210 may be an Automated Teller Machine (ATM), a computer, a telephone, a Personal Data Assistant (PDA), a server, or the like.

For example, the consumer 205 may interact with an interface that may be provided by the payment card system 220 to the first electronic device 210 by inputting information corresponding to an order for a payment card. The information may include, for example, a monetary amount to be applied to the payment card, an organization selected to receive a remaining balance of the payment card, a payment method for the monetary amount, a billing address of the consumer, a recipient name for the payment card, a delivery method, or the like. The information may then be received by the payment card system 220 and processed by the payment card provider 215 such that a payment card may be issued to a recipient for the monetary amount.

In another embodiment, as shown in FIG. 2B, the consumer 205 may also interact with a distribution entity 245 such as a merchant or other retail entity to purchase a payment card. For example, the payment card provider 215 may issue a plurality of payment cards to the distribution entity 245. The consumer 205 may then purchase and receive the payment cards from the distribution entity 245. According to one embodiment, the distribution entity 245 may include a device such as a cash register, computer, or the like that may be in communication with the payment card provider 215 via, for example, the network 230. A representative of the distribution entity 245 may then enter, via the device, information corresponding to the order of the payment card such as the monetary amount to be applied to the payment card, the organization selected to receive a remaining balance, or the like on behalf of the consumer 205.

The recipient 235 may be a beneficiary of the payment card that may be purchased by, for example, the consumer 205. According to example embodiments, the recipient 235 may receive the payment card as a gift from the consumer 205. The payment card may include a monetary balance corresponding to an amount paid by the consumer 205 for the payment card. The recipient 235 may use the payment card to purchase goods and/or services at a merchant such as a retail store, online store, or any other entity that may sell goods and/or services.

According to one embodiment, when the recipient 235 receives the payment card, the payment card may include an organization associated therewith that may be selected by the consumer 205 to receive a monetary balance that remains on the payment card.

According to another embodiment, when the recipient 235 receives the payment card, an organization may not be selected such that the recipient 235 may interact with, for example, the payment card provider 215, using the second electronic device 240, to select an organization to receive a balance that remains on the payment card. For example, as described above, the payment card system 220 may provide an interface to the second electronic device 240. The second electronic device 240 may include hardware components such as a processor, a graphics card, a storage component, a memory component, an antenna, a communication port, or the like. The second electronic device 240 may also include software components such as an operating system that may control the hardware components. According to example embodiments, the second electronic device 240 may be an Automated Teller Machine (ATM), a computer, a telephone, a Personal Data Assistant (PDA), a server, or the like. The recipient 235 may interact with the interface provided to the second electronic device 240 to select an organization to receive the balance that may remain on the payment card.

According to another embodiment, when neither the consumer 205 nor the recipient 235 selects an organization to receive a balance of the payment card, a default organization may receive the balance of the payment card. According to an example embodiment, the default organization may be pre-selected by the payment card provider 215. The consumer 205 and/or the recipient may then change the organization from the pre-selected default organization with their selections. In another embodiment, the default organization may selected upon the expiration of the payment card by the payment card provider 215.

As shown in FIG. 2A and 2B, an organization 225 may be in communication with the payment card provider 215. The organization 225 may be selected to receive a balance remaining on a payment card such as the payment card 100, shown in FIGS. 1A and 1B. For example, the payment card may include an expiration date. If the current date may be past the expiration date, the balance remaining on the payment card may be transferred or distributed to the organization 225. Additionally, a balance option may indicate to transfer the remaining balance to the organization 225. For example, a recipient may wish to transfer a remaining balance on the payment card prior to its expiration via, for example, an interface provided by the payment card provider, or by dispensing the payment card in, for example, an ATM. In such cases, a balance option that may indicate to close the account and transfer the remaining balance may be received by the payment card provider 215. The payment card provider 215 may then transferred or distributed to the organization 225.

According to example embodiments, the organization 225 may include a charity, an educational institution, a research institution, an environmental organization, an animal organization, a religious organization, an arts organization, a humanitarian aid organization, or the like. As described above, a consumer such as the consumer 205, a recipient such as the recipient 235, or a payment card provider such as the payment card provider 215 may select the organization 225.

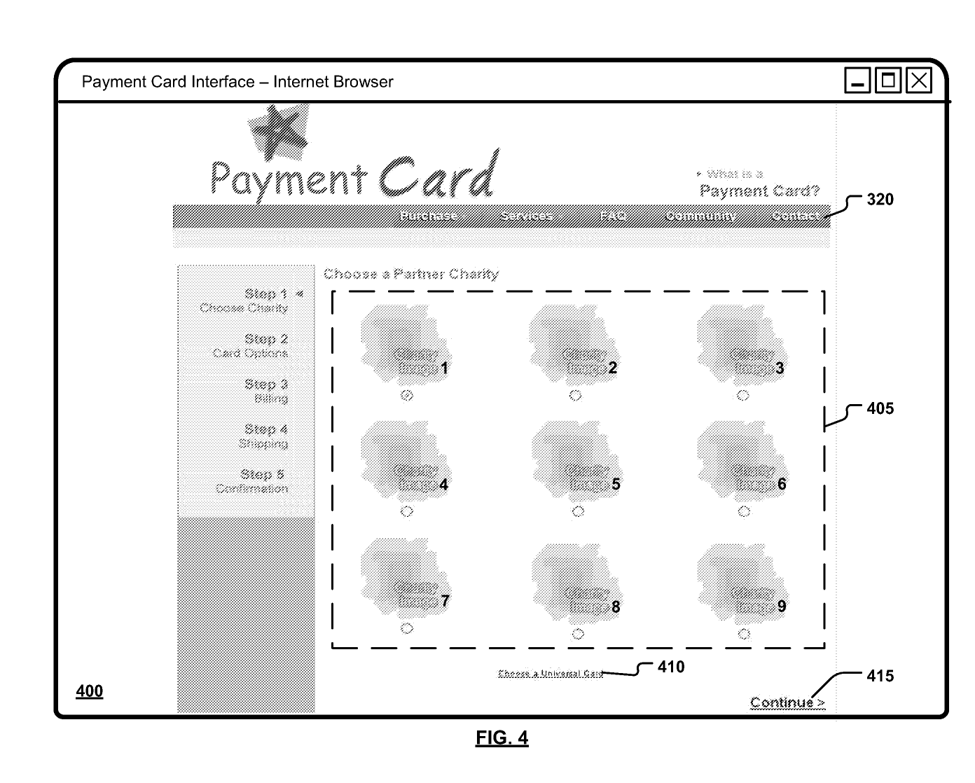

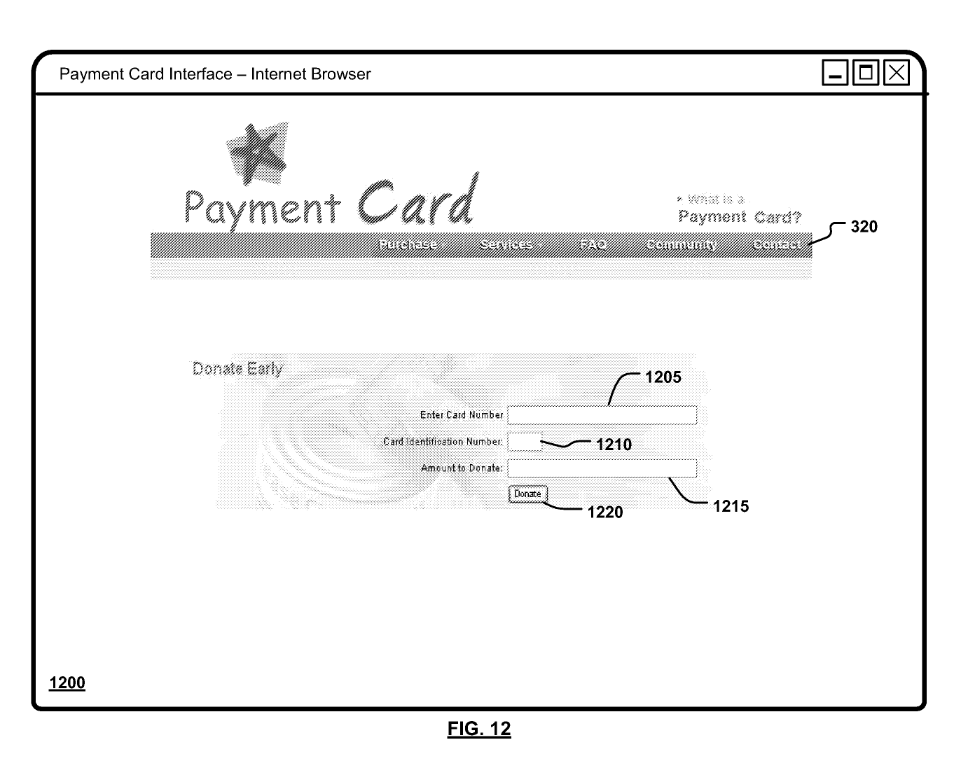

FIGS. 3-13 depict example interfaces for ordering a payment card, associating an organization with a payment card, and/or providing a balance of a payment card to an organization. According to an example embodiment, a payment card system such as the payment card system 220, shown in FIGS. 2A and 2B, may provide one or more interfaces to a consumer such as the consumer 205, shown in FIGS. 2A and 2B, and/or a recipient such as the recipient 235, shown in FIGS. 2A and 2B. The one or more interfaces may be web pages generated using, for example, HTML, Java, or the like. According to an example embodiment, the consumer and/or the recipient may access the one or more interfaces provided by the payment card system using a browser application such as an internet browser executing on an electronic device such as the first and second electronic device 210, 240, shown in FIGS. 2A and 2B. The consumer may then interact with the one or more interfaces to order a payment card such as the payment card 100, shown in FIGS. 1A and 1B, and/or to associate a payment card such as the payment card 100 with an organization. The recipient may then interact with the one or more interfaces to associate a payment card such as the payment card 100 with an organization and/or manage the payment card.

As shown in FIG. 3, an interface 300 such as a home page may be provided to a consumer and/or recipient upon accessing, for example, a website provided by the payment card system. According to one embodiment, the interface 300 may include options for ordering or purchasing a payment card including, for example, a partner card option 305 and a universal card option 310. The payment card option 305 and the universal card option 310 may include hyperlinks, buttons, or the like that may be clicked to order a payment card from a payment card provider, which will be described in more detail below.

The interface 300 may further include a card services options block 315. According to one embodiment, the card services option block 315 may include one or more options available for a payment card that may have already been purchased. For example, the card services option block 315 may include an associate card option that may be selected to, for example, associate a purchased payment card with an organization; a register card option that may be selected to, for example, register the payment card for replacement due to theft, loss, or the like; an account manager option that may be selected to, for example, manage an account associated with the payment card such as view an account balance, a transaction history, or the like; and a donate early option that may be selected to, for example, donate a portion of a balance of the payment card to the organization. According to example embodiments, the card services options block 315 may include one or more hyperlinks associated with the options that may be selected to direct a consumer or recipient to additional interfaces that may be used to associate an organization, manage an account, register a card, donate early, or the like, which will be described in more detail below.

The interface 300 may also include an options toolbar 320. The options toolbar 320 may include one or more options available for a payment card including, for example, ordering or purchasing a payment card, card services available for purchased payment cards, information about a payment card, a community forum, contact information, or the like. According to example embodiments, the one or more options may include drop down menus that a consumer and/or recipient may select to receive sub-options. For example, as shown in FIG. 3, the options toolbar 320 may include a purchase option and a services option. The consumer and/or recipient may click on the purchase option and/or the services options such that a drop down menu with additional options including, for example, purchase a partner card, purchase a universal card, associate an organization, register a card, manage an account, donate early, or the like may be selected. The consumer may then be directed to additional interfaces associated with the sub-options, which will be described in more detail below.

As shown in FIG. 3, the options toolbar 320 may include a community forum option that may be selected. The community forum option may direct a consumer and/or recipient to profiles that may be established by, for example, consumers, recipients, or the like. For example, an individual may access the interface 300 and may establish a profile page that may describe the organizations the individual wishes to receive a payment card associated therewith. The individual may also post stories or information that may indicate the importance of such organizations to the individual. If a consumer may wish to purchase or order a payment card for the individual, the consumer may access the profile associated with the individual by selecting, for example, the community forum option in the options toolbar 320. The consumer may then be directed to an interface (not shown) such that the consumer may search for and view a profile associated with the individual. The consumer may then use the information in the profile to select an organization that may be associated with a payment card being purchased for the individual.

According to one embodiment, upon selecting the partner card option 305 on the interface 300, shown in FIG. 3, an interface 400, shown in FIG. 4, may be provided. For example, upon clicking the partner card option 305, a consumer may be directed to the interface 400 to order a payment card associated with an organization that may be recommended by the payment card provider.

As shown in FIG. 4, the interface 400 may include the options toolbar 320, described above with respect to FIG. 3, and a partner selection block 405. The partner selection block 405 may include a plurality of organizations that may be featured or recommended by the payment card provider. In an example embodiment, the partner selection block 405 may include one or more radio buttons or checkboxes associated with a representation such as a logo, image, or the like of an organization recommended by the payment card provider. The consumer may click a radio button or checkbox in the partner selection block 405 that may be associated with each organization he or she wishes to receive a remaining balance on the payment card being purchased.

The interface 400 may further include a universal card option 410. The universal card option 410 may include a hyperlink, button, or the like that may be clicked to direct a consumer to an interface associated with purchasing or ordering a universal card, which will be described in more detail later.

The interface 400 may further includes a continue option 415. The continue option 415 may include a button, hyperlink, or the like that may be clicked, after selecting an organization provided in the partner selection block 405, to submit the input information to, for example, a payment card system hosted by the payment card provider and to direct the consumer to additional interfaces for ordering a payment card. According to example embodiments, the continue option 415 may be dynamic such that the continue option 415 may be provided on the interface 400 if a consumer selects a radio button or check box associated with an organization in the partner selection block 405.

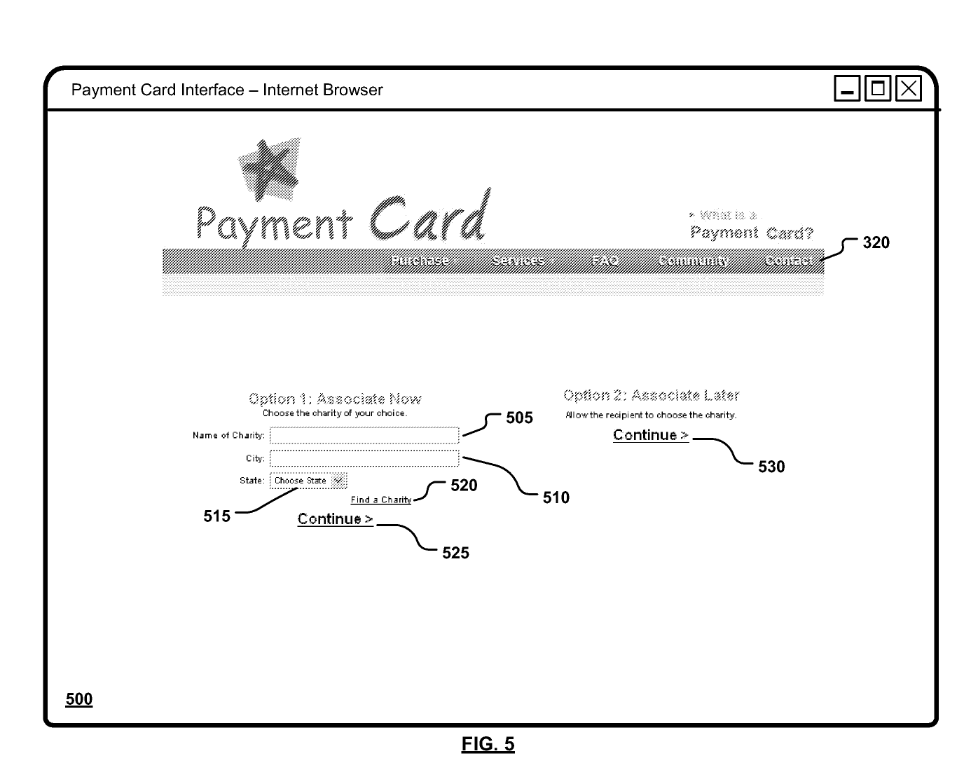

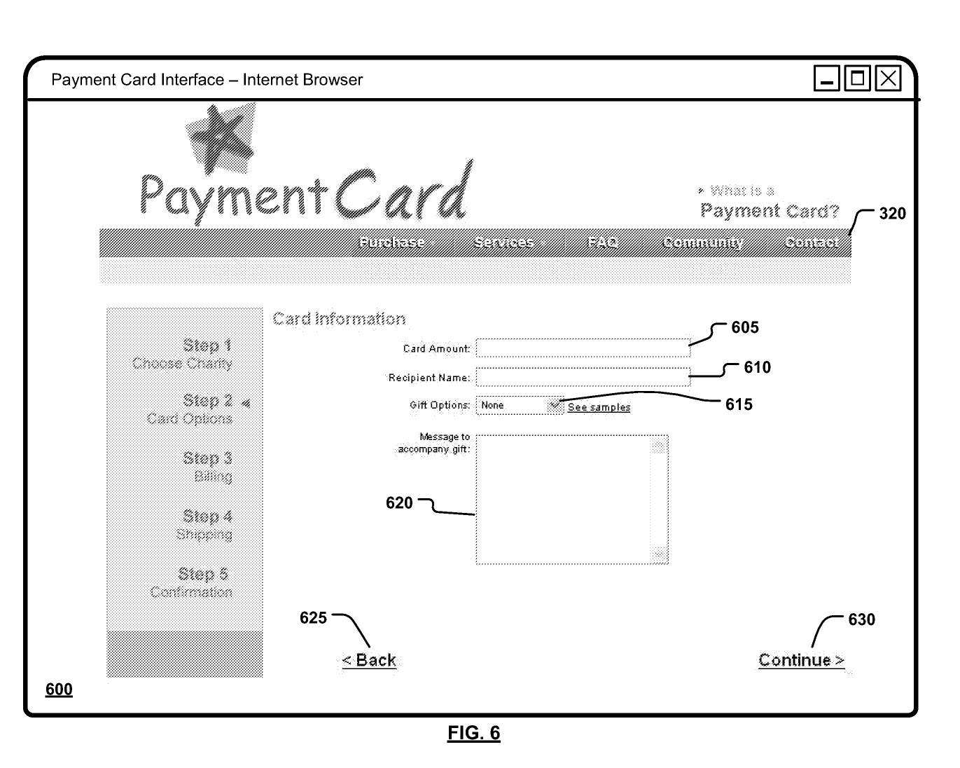

As described above, the interface 300, shown in FIG. 3, may also include the universal card option 310. According to one embodiment, upon selecting the universal card option 310 on the interface 300, shown in FIG. 3, an interface 500, shown in FIG. 5, may be provided. For example, upon clicking the universal card option 310, a consumer may be directed to the interface 500 to order a payment card associated with an organization that may be selected by the consumer.

As shown in FIG. 5, the interface 500 may be an interface that may be used by the consumer to enter an organization that may be associated with a payment card being purchased. According to an example embodiment, the interface 500 may include the options toolbar 320, described above with respect to FIG. 3, an organization name block 505, a first location block 510, and a second location block 515. The organization name block 505 may include an input block such as a text block that may receive, for example, a name of each organization that may be selected by the consumer to receive a remaining balance on the payment card being purchased. Similarly, the first location block 510 may include an input block such as a text block that may receive a first location such as a city associated with the organization entered into the organization name block 505. Additionally, the second location block 515 may include a drop down box or a list that may include a plurality of second location such as states that may be associated with the first location entered into the first location block 510.

The interface 500 may also include a find an organization option 520. The find an organization option 520 may include a hyperlink, button, or the like that may be selected to find, for example, an organization that may already be registered with the payment card provider. According to one embodiment, the find an organization option 520 may be clicked such that the consumer may be directed to another interface (not shown) to search for an organization that may be selected to be associated with the payment card being purchased.

The interface 500 may further include a first continue option 525 and a second continue option 530. The first continue option 525 may include a button, hyperlink, or the like that may be clicked, after entering information in the organization name block 505, the first location block 510, and the second location block 515, to submit the entered information to, for example, a payment card system hosted by the payment card provider and to direct the consumer to additional interfaces for ordering a payment card. According an example embodiment, the first continue option 525 may be dynamic such that the first continue option 525 may be provided on the interface 500 if a consumer enters suitable information in the organization name block 505, the first location block 510, and the second location block 515.

Similarly, the second continue option 530 may include a button, hyperlink, or the like that may be clicked to order a payment card without an organization associated therewith. For example, the consumer may purchase a payment card such as a blank or universal payment card that may not include an organization selected by the consumer purchasing the payment card. After receiving the payment card, a recipient may then associate an organization with the payment card, which will be described in more detail below.

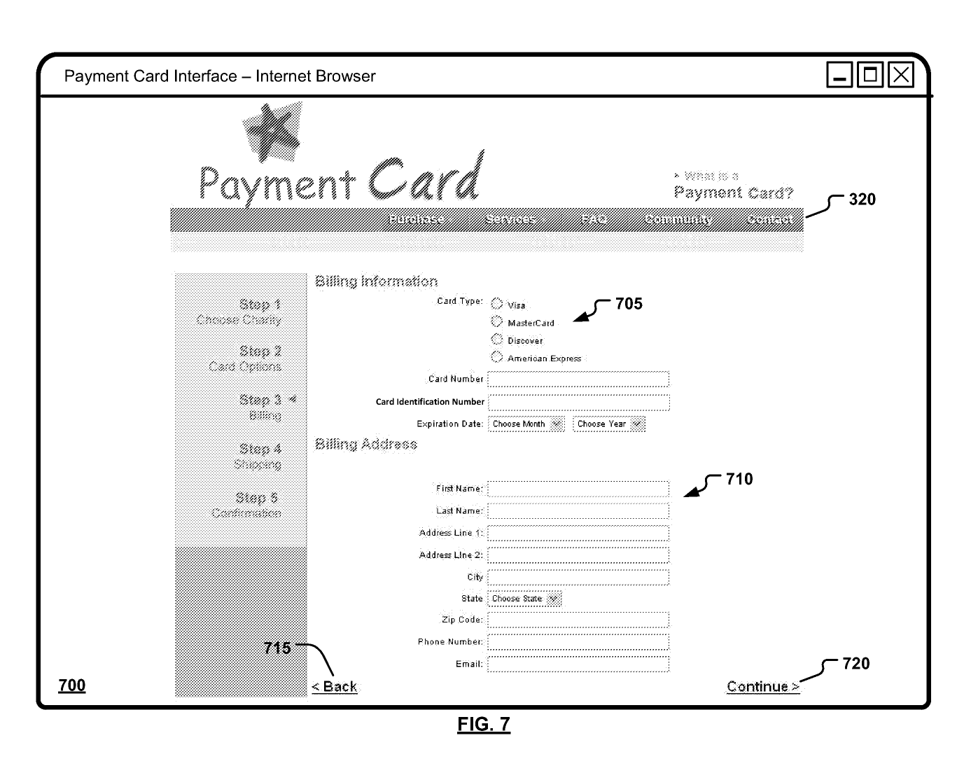

Upon clicking the continue option 415, shown in FIG. 4, or one of the continue options 525, 530, shown in FIG. 5, the consumer may be directed to an interface 600, shown in FIG. 6. The interface 600 may be provided to receive card information associated with the payment card being purchased. The interface 600 may include the options toolbar 320, described above with respect to FIG. 3, a card amount block 605, a recipient name block 610, a gift option block 615, and a message block 620.

The card amount block 605, the recipient name block 610, and the message block 620 may include input blocks such as text boxes that may receive respectively an amount to be credited to the payment card being purchased, the name of a recipient receiving the payment card being purchased, and a message such as a greeting from the consumer to a recipient receiving the payment card being purchased. According to an example embodiment, the message may be printed or rendered on a greeting card, note card, or the like that may be provided with the payment card being purchased.

The gift option block 615 drop down box or a list that may include a plurality of gift options that may be associated with the payment card being ordered. The plurality of gift options may include, for example, a birthday, an anniversary, a holiday such as Christmas, a graduation, a congratulations, or the like. As described above, a greeting card may be provided with the payment card. According to one embodiment, the greeting card may be a card associated with a selected gift option from the gift option block 615. For example, the greeting card may be a birthday card, a graduation card, an anniversary card, or the like. Additionally, the payment card being purchases may be wrapped in paper corresponding to the gift option selected from the gift option block 615.

The interface 600 may further include a back option 625 and a continue option 630. The back option 625 may include a button, hyperlink, or the like that may be clicked to go back to a previous interface such as the interface 400, shown in FIG. 4, or the interface 500, shown in FIG. 5, such that the consumer may modify, for example, an organization from the partner selection block 405, shown in FIG. 4, or the organization name block 505, shown in FIG. 5. The continue option 630 may include a button, hyperlink, or the like that may be clicked after entering information in the card amount block 605, the recipient name block 610, the gift option block 615 and/or the message block 620 to submit the entered information to, for example, a payment card system hosted by the payment card provider and to direct the consumer to additional interfaces for ordering a payment card. According to example embodiments, the continue option 630 may be dynamic such that the continue option 630 may be provided on the interface 600 if a consumer enters information in, for example, the card amount block 605 and/or the recipient name block 610.

In one embodiment, upon clicking the continue option 630 on the interface 600, the consumer may be directed to an interface 700, shown in FIG. 7. The interface 700 may be provided to receive billing information associated with the consumer that may be purchasing the payment card. The interface 700 may include the options toolbar 320, described above with respect to FIG. 3, a billing information portion 705, and a billing address portion 710.

The billing information portion 705 may include a card type option area that may include the payment options available to the consumer for ordering the payment card. For example, the card type option area may include one or more radio buttons, checkboxes, or the like that may be associated with credit or debit card companies such as Visa®, MasterCard®, American Express®, or the like for a credit or debit card being used to purchase the payment card. The billing information portion 705 may also include a radio button, check box, or the like associated with a bank account option such as a checking or savings account option. The billing information portion 705 may further include a card number block and a card identification number block. The card number block may include an input block such as a text box that may receive, for example, an account number for a credit or debit card, a routing number for a bank or savings account, or the like being used to purchase the payment card. The card identification number block may include an input block such as a text box that may receive, for example, a security code or any other suitable account verification number that may be used to authenticate the account number, routing number, or the like being used to purchase the payment card. The billing information portion may further include an expiration date area. The expiration date area may include a first drop down box or list that may include a month associated with the expiration date of the credit or debit card being used to purchase a payment card and a second drop down box or list that may include a year associated with the expiration date of the credit or debit card being used to purchase a payment card.

The billing address portion 710 may include a plurality of input boxes as text boxes, a drop down box or list, or the like to receive a first name, a last name, an address, a phone number, an email, or the like or the like associated with the credit or debit card that may be used by the consumer to purchase the payment card.

The interface 700 may further include a back option 715 and a continue option 720. The back option 715 may include a button, hyperlink, or the like that may be clicked to go back to a previous interface such as the interface 600, shown in FIG. 6, to modify or review the card information. The continue option 720 may include a button, hyperlink, or the like that may be clicked, after entering information in the billing information portion 705 and the billing address portion 710, to submit the entered information to, for example, a payment card system hosted by the payment card provider and to direct the consumer to additional interfaces for ordering a payment card. According to example embodiments, the continue option 720 may be dynamic such that the continue option 720 may be provided on the interface 700 if a consumer enters information in, for example, the billing information portion 705 and the billing address portion 710.

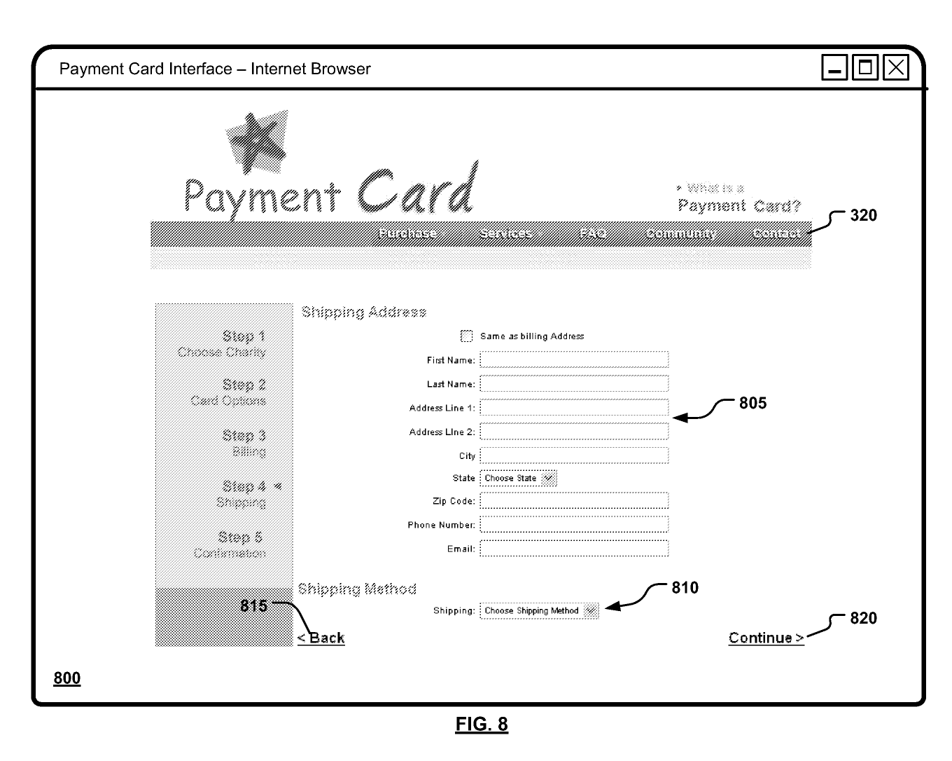

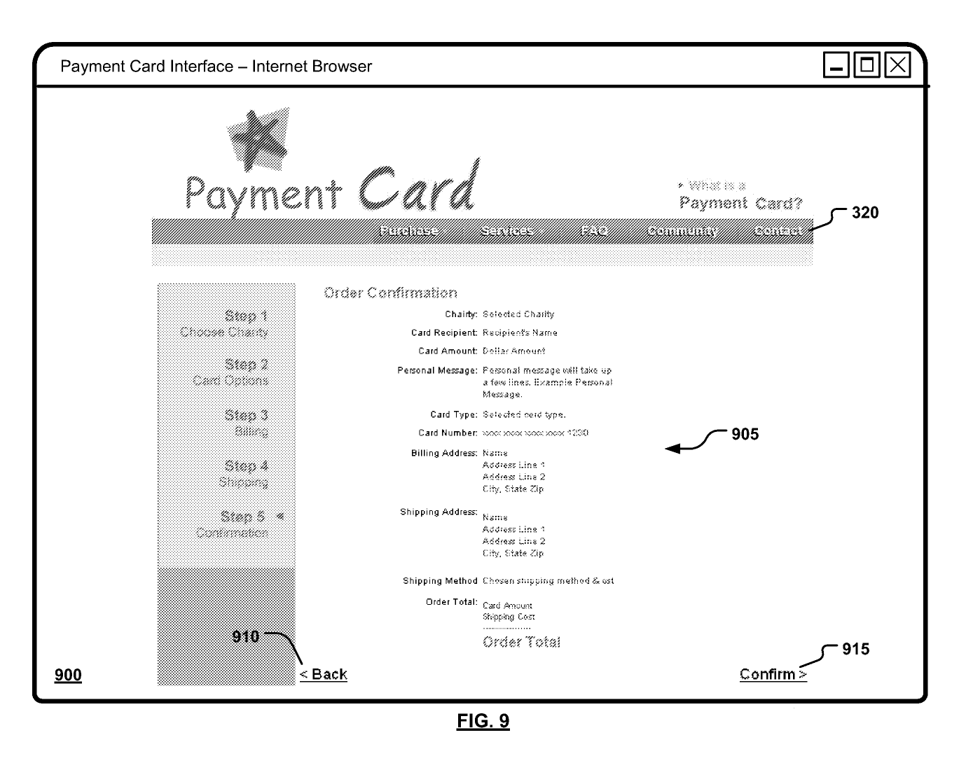

In one embodiment, upon clicking the continue option 720 on the interface 700, the consumer may be directed to an interface 800, shown in FIG. 8. The interface 800 may be provided to receive shipping information for the payment card being purchased. The interface 800 may include the options toolbar 320, described above with respect to FIG. 3, a shipping address portion 805 and a shipping method portion 810.

The shipping address portion 805 may include a plurality of input boxes as text boxes, a drop down box or list, or the like to receive a first name, a last name, an address, a phone number, an email, or the like or the like associated with the shipping information for the payment card. The shipping address portion 805 may also include a check box or radio button that may be selected to use the same shipping address as the billing address that may be input into the interface 700, described above with respect to FIG. 7.

The shipping method portion 810 may include a drop down box or list that may include a plurality of shipping options available for a payment card being purchased. According to one embodiment, the shipping options may include U.S. Postal Service, UPS®, FedEx®, or the like.

The interface 800 may further include a back option 815 and a continue option 820. The back option 815 may include a button, hyperlink, or the like that may be clicked to go back to a previous interface such as the interface 700, shown in FIG. 7, to modify or review the billing information. The continue option 820 may include a button, hyperlink, or the like that may be clicked, after entering information in the shipping address portion 805 and the shipping method portion 810, to submit the entered information to, for example, a payment card system hosted by the payment card provider and to direct the consumer to additional interfaces for ordering a payment card. According to example embodiments, the continue option 820 may be dynamic such that the continue option 820 may be provided on the interface 800 if a consumer enters information in, for example, the shipping address portion 805, and the shipping method portion 810.

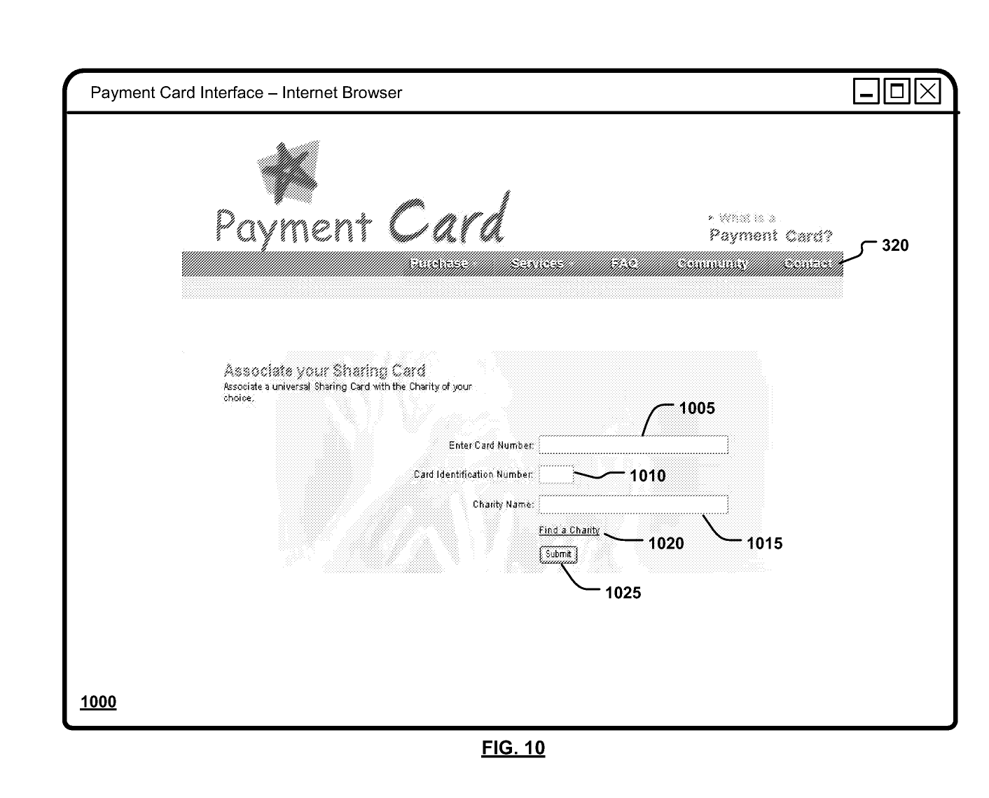

In one embodiment, upon clicking the continue option 820 on the interface 800, the consumer may be directed to an interface 900, shown in FIG. 9. The interface 900 may be provided to display a confirmation of the order submitted for the payment card being purchased. The interface 900 may include the options toolbar 320, described above with respect to FIG. 3, and an order confirmation portion 905.

The order confirmation portion 905 may include a summary of the information entered, selected, or input into, for example, the interfaces described in FIGS. 4-8. For example, the order confirmation portion 905 may include the selected organization, the recipient name, the card amount, the billing address, the shipping address, the payment method, the shipping method, an order total, or the like.

The interface 900 may further include a back option 910 and a continue option 915. The back option 910 may include a button, hyperlink, or the like that may be clicked to go back to a previous interface such as the interface 800, shown in FIG. 8, to modify or review the shipping information. The continue option 915 may include a button, hyperlink, or the like that may be clicked, after reviewing the summary, to finalize the order and submit the information to, for example, a payment card system hosted by the payment card provider. The payment card system may process the order to generate an account with the card amount, store an association of one or more selected organizations, and issue a payment card based on the received information. Additionally, the credit card, debit card, bank account, or the like that may be used to purchase the payment card may be charged. According to one embodiment, upon clicking the continue option 915, a consumer may be provided with a confirmation number associated with the order as well as a receipt for the order of the payment card being purchased.

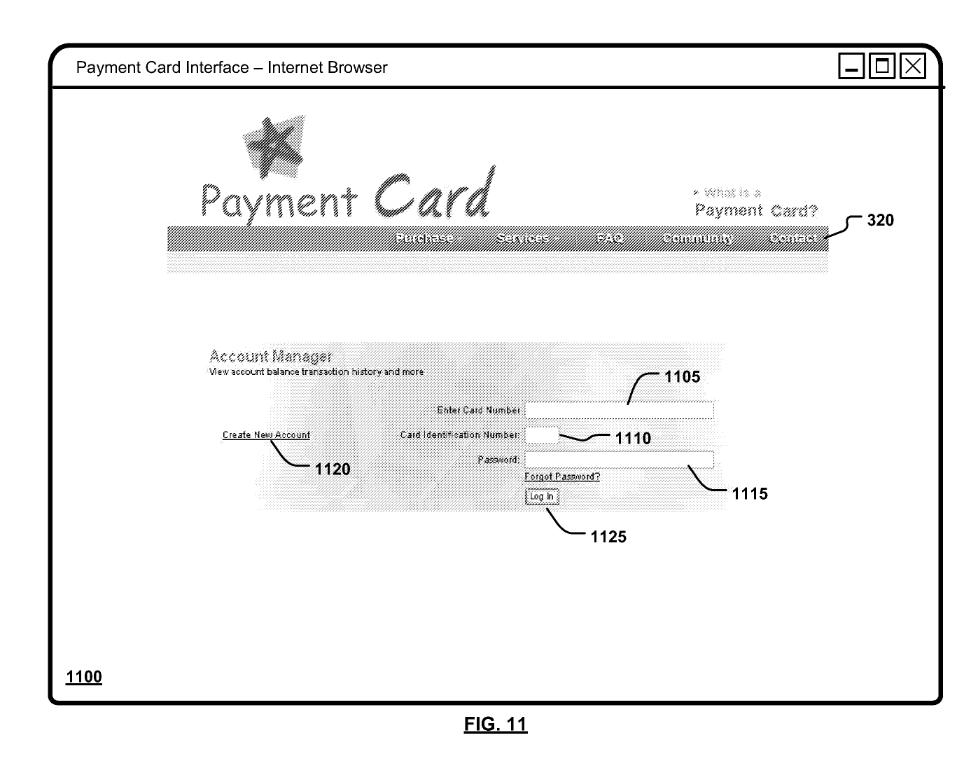

FIGS. 10-12 depict example interfaces that may be accessed by, for example, selecting an option that may be provided in, for example, the card services option block 315 of the interface 300, described above with respect to FIG. 3. For example, as described above, the card services option block 315 may include an associate an organization option. According to one embodiment, upon selection of the associate card option, an interface 1000, shown in FIG. 10, may be provided to, for example, a recipient of a purchased payment card.

The interface 1000 may include an account information block 1005 and an account identification block 1010. The account information block 1005 may include an input block such as a text box that may receive, for example, account information associated with a purchased payment card. For example, the recipient may input, via the account information block 1005, an account identifier such as an account number of a purchased payment card for which the recipient wishes to select an organization. The account identification block 1010 may include an input block such as a text box that may receive, for example, a security code associated with the purchased payment card.

The interface 1000 may further include an organization name block 1015 and a find a charity option 1020. The organization name block 1015 may include an input block such as a text block that may receive, for example, a name of one or more organizations that may be selected by the recipient to receive a balance of a purchased payment card. The organizations may include, for example, a charity, an educational institution, a research institution, an environmental organization, an animal organization, a religious organization, an arts organization, a humanitarian aid organization, or the like. According to one embodiment, the consumer may select the find a charity option 1020 to be directed to another interface (not shown) that may be used to search for and select an organization to associate with the payment card

The interface 1000 may further include a submit option 1025. The submit option 915 may include a button, hyperlink, or the like that may be clicked to submit the input account information of a purchased payment card and selected organization to, for example, a payment card system hosted by the payment card provider. The payment card system may then associate the selected organization with the account information of the purchased payment card such that the selected organization received from the interface 1000 may receive a residual balance of the purchased payment card.

As described above with respect to FIG. 3, the card services option block 315 may further include an account manager option. According to one embodiment, upon selection of the account manager option, an interface 1100 may be provided to, for example, a recipient of a purchased payment card.

The interface 1100 may include an account information block 1105 and an account identification block 1110. The account information block 1105 may include an input block such as a text box that may receive, for example, account information associated with a purchased payment card. For example, the recipient may input, via the account information block 1105, an account identifier such as an account number of a purchased payment card for which the recipient wishes to access account information such as a current balance, a transaction history, or the like. The account identification block 1110 may include an input block such as a text box that may receive, for example, a security code associated with the purchased payment card.

The interface 1100 may further include a password block 1115. The password block 1115 may include an input block such as a text block that may receive, for example, a password associated with account information of a purchased payment card for being accessed. According to one embodiment, a recipient may create an online account associated with a purchased payment card received by the recipient. For example, the interface 1100 may include a new account option 1120 that may be selected to create an online account for a purchased payment card. When creating the online account, the recipient may be prompted to input a password to associate with account information of a payment card. The recipient may then provide the password via the password block 1115 to access an account manager interface (not shown). The account manager interface (not shown) may include an account balance, a transaction history, or the like associated with the account information of a payment card.

The interface 1100 may further include a log in option 1125. The log in option 1125 may include a button, hyperlink, or the like that may be clicked to submit the account information of a purchased payment card and a corresponding password to, for example, a payment card system. Upon receipt of the account information and password, the payment card system may then provide an account manager interface that may show an account balance, a transaction history, or the like for the received account information and password.

As described above with respect to FIG. 3, the card services option block 315 may further include a donate early option. According to one embodiment, upon selection of the donate early option, an interface 1200 may be provided to, for example, a recipient of a purchased payment card.

The interface 1200 may include an account information block 1205 and an account identification block 1210. The account information block 1205 may include an input block such as a text box that may receive, for example, account information associated with a purchased payment card. For example, the recipient may input, via the account information block 1205, an account identifier such as an account number of a purchased payment card that the recipient wishes to use to donate a monetary amount to the organization associated therewith. The account identification block 1210 may include an input block such as a text box that may receive, for example, a security code associated with the purchased payment card.

The interface 1200 may include a donation amount block 1215. The donation amount block 1215 may include an input block such as a text block that may receive, for example, a monetary amount to be deducted from a balance of the purchased payment card and donated to the organization associated therewith.

According to another embodiment, the interface 1200 may also include donate balance option (not shown). The donate balance option may include a check box or radio button (not shown) that may selected by, for example, the recipient to donate a remaining balance of a purchased payment card to the organization associated therewith.

The interface 1200 may further include a donate option 1220. The donate option 1220 may include a button, hyperlink, or the like that may be clicked to submit the account information and donate balance or donation amount to, for example, a payment card system. The payment card system may then process the received information by, for example, debiting the account balance or the donation amount associated with the received account information for the purchased payment card and providing the account balance or the donation amount to the organization associated therewith.

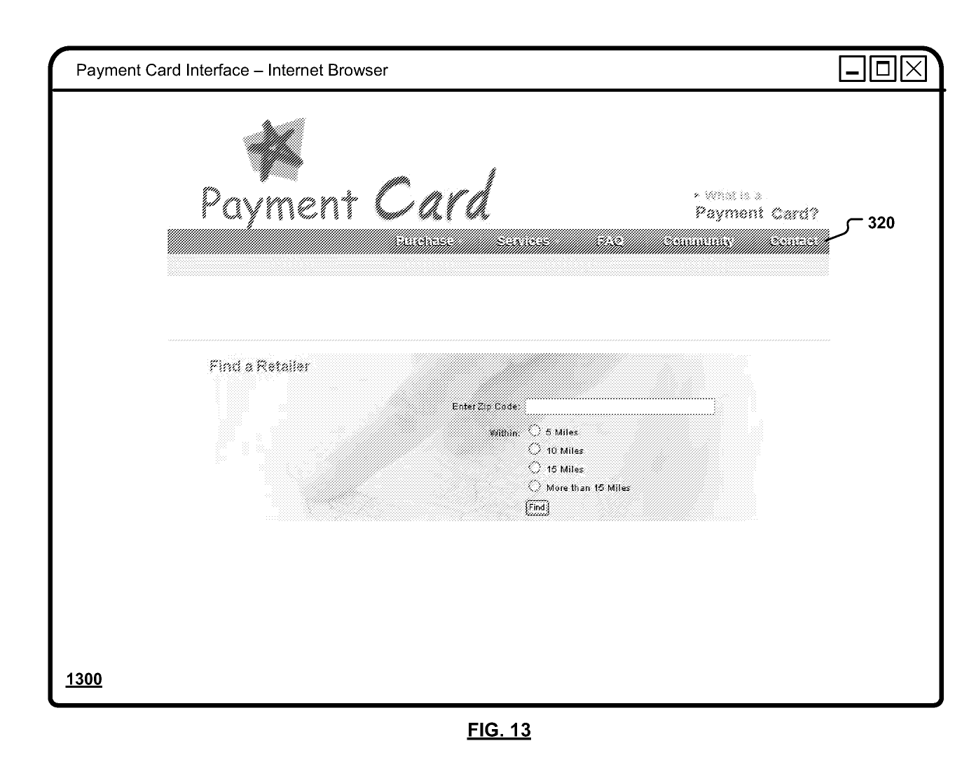

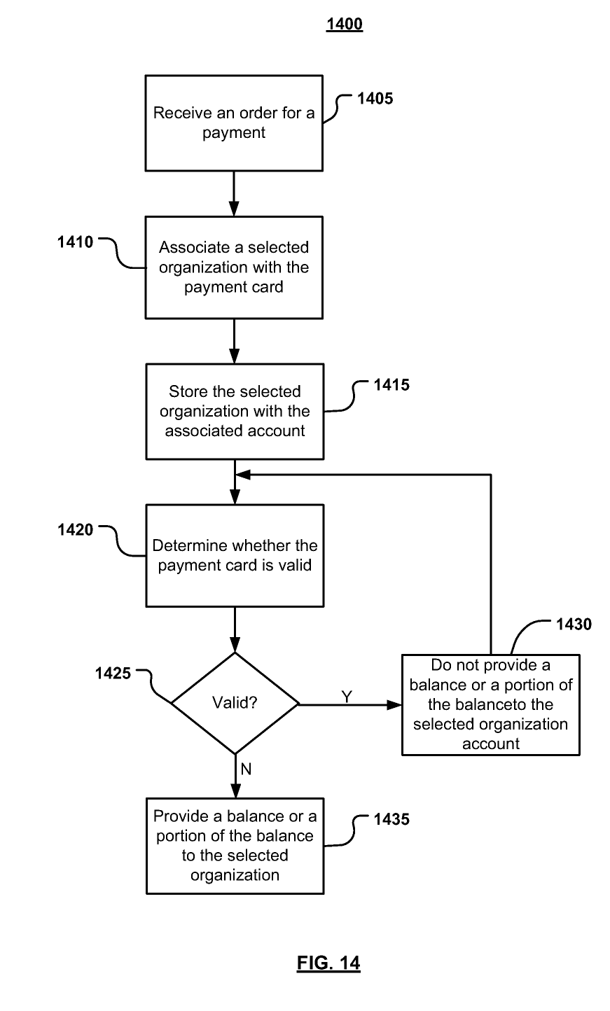

FIG. 13 depicts an example interface 1300 that may be provided to a consumer to find a retailer that may sell a payment card that may be associated with an organization. For example, the consumer may access the interface 1300 provided by a payment card system. The consumer may then interact with the interface 1300 to search for a distribution entity such as a merchant that may sell a payment card that may be associated with an organization at, for example, a retail location of the distribution entity.

FIG. 14 depicts a flow diagram of an example method 1400 for ordering a payment card, associating an organization with a payment card, and/or providing an account balance of a payment card to an organization. According to one embodiment, the example method 1400 may be performed by the systems described above in FIGS. 2A and 2B such as the payment card system 220 and/or the interfaces described above in FIGS. 3-13. At 1405, an order for a payment card such as the payment card 100 described above in FIGS. 1A and 1B may be received. According to one embodiment, a consumer may purchase a payment card via one or more interface such as web pages associated with a payment card provider. For example, a payment card provider may include a payment card system. A consumer may interact with one or more interfaces that may be provided by the payment card system such that the payment card provider may receive order information for a payment card via the one or more interfaces provided by the payment card system.

According to another embodiment, the consumer may purchase the payment card via a distribution entity such as such as a merchant or other retail entity to order a payment card from the payment card provider. For example, the payment card provider may issue a plurality of payment cards to the distribution entity. The consumer may then purchase and receive the payment cards from the distribution entity. According to one embodiment, the distribution entity may include a device such as a cash register, computer, or the like that may be in communication with the payment card provider. A representative of the distribution entity such as a cashier may enter, via the device, information corresponding to the order of the payment card such as the monetary amount to be applied to the payment card, each organization selected to receive a balance or a portion of a balance of the payment card, or the like on behalf of the consumer. The payment card provider may receive an indication of the order entered by from the device. According to example embodiments, the payment card provider may include a payment card system that may receive the order from the device of the distribution entity.

At 1410, a selected organization may be associated with the payment card. The selected organization may include a charity, an educational institution, a research institution, an environmental organization, an animal organization, a religious organization, an arts organization, a humanitarian aid organization, or the like.

According to one embodiment, a consumer and/or a recipient may interact with an interface that may be provided by the payment card system to select, for example, an organization that may receive an account balance that may remain on a payment card. According to one embodiment, the payment card provider may recommend an organization that may be associated with the payment card. Alternatively, the recipient and/or the consumer may enter information for the organization the recipient and/or the consumer wishes to receive a residual balance. The payment card system may then receive the information input into the interface including the selected organization such that the payment card system may associate the selected organization with an account of the payment card. According to one embodiment, the selected organization may be received, at 1405, with the order information provided by a consumer purchasing a payment card and associated with the payment card at 1410.

In another embodiment, the payment card may be an issued payment card that may not have an organization associated therewith. In an example embodiment, the consumer and/or the recipient may select the organization when, for example, activating the payment card. According to another embodiment, the payment card provider may select the organization. For example, a default organization may be selected by the payment card provider when neither the consumer nor the recipient selects an organization.

According to an example embodiment, the consumer, the recipient, and/or the payment card provider may select a plurality of organizations to receive a balance of a payment card such that each of the selected organizations may be provided with a percentage of the balance of the payment card. At 1410, each of the selected organizations may be associated with the payment card.

At 1415, the payment card system may store the association of the selected organization(s) with the account of the payment card. For example, the payment card system may include a storage component such as a hard drive, Random Access Memory (RAM), Read-Only Memory (ROM), cache, or the like that may be used to store the account of the payment card and the selected organization(s) that may be associated with the account of the payment card

At 1420, the payment card system may determine whether the payment card may be valid. For example, the account of the payment card may have an expiration date such as one year, eighteen months, or the like after the date the account may be created or generated. According to one embodiment, the payment card system may compare a current date with the expiration date to determine whether the current date may be past the expiration date. Additionally, the payment card system may also determine whether the payment card may be valid by determining whether a balance option indicates to transfer a portion of the balance from the account. For example, the recipient may decide to close the account and transfer the remaining balance to the organization before the expiration date of the account. Additionally, the recipient may decide to transfer a portion of a remaining balance to the organization(s) prior to the expiration of the payment card. To close the account and/or transfer a portion of a remaining balance, the recipient may interact with an interface such as a web page, an ATM, or the like to select a balance option that indicates to transfer the remaining balance or a portion of the remaining balance.

At 1425, if the payment card may be valid, a balance or a portion of the balance may not be provided to the selected organization(s) associated with the account of the payment card at 1430. For example, if the current date may be before the expiration date or a balance option that indicates to transfer at least a portion of a remaining balance may not have been received, the payment card may remain valid and the remaining balance may not be provided to the selected organization(s). The payment card system may then wait until the end of a cycle such as the next day to re-determine whether the payment card may be valid.

At 1425, if the payment card may be invalid, a balance or a portion of the balance may be provided to the selected organization(s) associated with the payment card at 1435. For example, if the current date may be past the expiration date or a balance option indicates to transfer at least a portion of a remaining balance, the balance or the portion of the balance may be provided to the selected organization(s). In one embodiment, a receipt may be provided to the consumer and/or the recipient. The receipt may provide an indication of payment of the balance or the portion of the balance to the selected organization(s).

According to one embodiment, to provide the balance or the portion of the balance to the selected organization(s), the balance or the portion of the balance may be transferred to an account associated with the selected organization(s). For example, the payment card provider may include an account for each of the organizations. At 1425, if the payment card may be invalid, the balance or the portion of the balance may be transferred to an account of the selected organization(s) associated with the payment card provider. The payment card provider may then issue a check or electronically transfer a balance of the account associated with the selected organization(s). According to one embodiment, the balance may include an accrued balance of all the payment cards associated with the organization(s). The payment card provider may issue the check or electronically transfer the balance at various time intervals such as every month, every other month, every three months, or any other suitable time interval.

In an example embodiment, a cost reimbursement charge associated with the payment card may be deducted from the account of the selected organization(s) prior to providing the balance or the portion of the balance to the selected organization. For example, the cost reimbursement chart may be deducted from the balance or the portion of the balance prior to transferring the balance or the portion of the balance to the account associated with the selected organization(s).

While example embodiments of a payment card, methods for ordering a payment card and/or associating an organization with a payment card, and systems such as a payment card selection system for ordering a payment card and/or associating an organization with a payment card have been described, the underlying concepts may be performed in a variety of systems such as computers, servers, or the like such that a payment card may be ordered and/or associated with an organization that may receive an account balance of the payment card. Additionally, the underlying concepts may be embodied in the form of computer executable instruction (i.e., program code) stored on a computer-readable storage medium which instructions, when executed by a machine, such as a computer, perform and/or implement the methods and systems described above. Specifically, any of the steps, operations or functions described above may be implemented in the form of such computer executable instructions. Computer readable storage media include both volatile and nonvolatile, removable and non-removable media implemented in any method or technology for storage of information. Computer readable storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by a computer.

1. A payment card having account information associated therewith, the payment card comprising:
a substrate; and
a magnetic stripe adhered to a first side of the substrate, wherein the magnetic stripe is encoded with the account information, and wherein the account information is associated with an organization that is selected to receive a residual account balance of the payment card.

2. The payment card of claim 1, wherein the account information encoded in the magnetic stripe comprises an account identifier and an expiration date.

3. The payment card of claim 2, further comprising:
a first representation of the account identifier embossed on a second side of the substrate; and
a second representation of the expiration date embossed on the second side of the substrate.

4. The payment card of claim 3, further comprising a recipient identifier embossed on the second side of the substrate.

5. The payment card of claim 4, further comprising an emblem adhered to at least one of the first and second sides of the substrate, wherein the emblem comprises at least one of following: text, graphics, a picture, a logo, and a hologram.

6. The payment card of claim 5, wherein the emblem is associated with the organization.

7. The payment card of claim 1, wherein the payment card comprises a prepaid gift card.

8. The payment card of claim 1, wherein the organization comprises at least one of the following: a charity, an educational institution, a research institution, an environmental organization, an animal organization, a religious organization, an arts organization, and a humanitarian aid organization.

9. A method of ordering a payment card, the method comprising:
receiving order information for purchasing a payment card, wherein the order information comprises a balance being credited to the payment card and an organization selected to receive a remaining balance of the payment card;
generating an account for the payment card, wherein the account comprises the monetary balance and an indication of the selected organization; and
issuing the payment card corresponding to the generated account.

10. The method of claim 9, further comprising:
determining whether the payment card is valid; and
providing the remaining balance to the organization if, based on the determination, the payment card is invalid.

11. The method of claim 10, wherein the account comprises an expiration date of the payment card.

12. The method of claim 11, wherein determining whether the payment card is valid comprises comparing a current date with the expiration date.

13. The method of claim 12, wherein the monetary balance is provided to the organization if, based on the comparison, the current date is past the expiration date.

14. The method of claim 10, further comprising receiving a balance option.

15. The method of claim 14, wherein determining whether the payment card is valid comprises determining whether the balance option indicates to transfer the remaining balance to the organization.

16. The method of claim 15, wherein the monetary balance is provided to the organization if, based on the determination, the balance option indicates to transfer the remaining balance to the organization.

17. The method of claim 16, wherein the organization comprises at least one of the following: a charity, an educational institution, a research institution, an environmental organization, an animal organization, a religious organization, an arts organization, and a humanitarian aid organization.

18. A method of associating an organization with an account of a payment card, the method comprising:
receiving a selection of the organization, wherein the organization is selected to receive an account balance associated with the account of the payment card;
associating the selected organization with the account of the payment card; and
storing the association of the selected organization with the account of the payment card.

19. The method of claim 18, wherein the selection of the organization is received from a consumer purchasing the payment card, and wherein the payment card is issued based on the received selection from the consumer.

20. The method of claim 18, wherein the selection of the organization is received from a recipient of the payment card.

21. The method of claim 18, further comprising:
determining whether the payment card is valid; and
providing the account balance to the organization if, based on the determination, the payment card is invalid.

22. The method of claim 21, wherein determining whether the payment card is valid comprises comparing a current date with an expiration date associated with the account of the payment card, and wherein the account balance is provided to the organization if, based on the comparison, the current date is past the expiration date associated with the account.

23. The method of claim 21, wherein determining whether the payment card is valid comprises determining whether a balance option indicates to transfer the remaining balance to the organization, and wherein the account balance is provided to the organization if, based on the determination, the balance option indicates to transfer the account balance to the organization.

24. The method of claim 23, wherein the balance option comprises an option to close the account.

25. The method of claim 18, wherein the organization comprises at least one of the following: a charity, an educational institution, a research institution, an environmental organization, an animal organization, a religious organization, an arts organization, and a humanitarian aid organization.

26. A method of providing a balance of a payment card to an organization, the method comprising:
associating a selected organization with the payment card;
determining whether the payment card is valid; and
providing the balance to the organization if, based on the determination, the payment card is invalid.

27. The method of claim 26, wherein providing the balance to the organization if, based on the determination, the payment card is invalid further comprises:
deducting a reimbursement charge from the balance;
transferring the balance less the reimbursement charge to an account of the selected organization; and
transferring an account balance of the account to the selected organization, wherein the account balance comprises at least the balance less the reimbursement charge.

28. The method of claim 26, wherein the organization comprises at least one of the following: a charity, an educational institution, a research institution, an environmental organization, an animal organization, a religious organization, an arts organization, and a humanitarian aid organization.
